(19) United States
(12) Patent Application Publication
(10) Pub. No.: US 2006/0108359 A1
(43) Pub. Date: May 25, 2006

(54) High speed microwave susceptor pattern application

(75) Inventors: Thomas C. Brough, High Point, NC (US); Michael M. Dekel, Woodland Hills, CA (US)

Correspondence Address: THE ECLIPSE GROUP, 10605 BALBOA BLVD., SUITE 300, GRANADA HILLS, CA, 91344, US

(73) Assignee: Halifax Scott, High Point, NC (US)

(21) Appl. No.: 11/266,531

(22) Filed: Nov. 3, 2005

Related U.S. Application Data
(60) Provisional application No. 60/625,417, filed on Nov. 4, 2004.

(51) Int. Cl. H05B 6/80

(52) U.S. Cl. 219/730

(57) ABSTRACT

The disclosure for High-Speed Microwave Susceptor Pattern Application discusses various methods for applying microwave susceptor material from a foil web to packaging, particularly food packaging such as folded carton flats. Typically, the microwave susceptor is applied in a pattern rather than uniformly to the packaging. The application can be done at high speeds using a modified form of cold foil printing or hot-stamp foil printing. The application can be done using hot-stamp sheet fed equipment to make use of legacy equipment. This abstract is intended to help those conducting a patent search for relevant disclosures and not intended as a limit on the scope of the claims.

This application claims priority to and incorporates by reference a co-pending and commonly assigned U.S. Provisional Patent Application No. 60/625,417 filed Nov. 4, 2004 titled Methods and Foil for High-Speed Application of Microwave Susceptor.

### BACKGROUND OF THE INVENTION

### Field of the Invention

The present invention makes a contribution to the field of packaging. More specifically, the present invention makes a contribution to packaging such as food packaging by providing a method and suitable materials to apply microwave susceptors in a wide range of patterns to allow the creation of packaging that augments the heating provided by exposure to microwaves with heat from conduction or radiation as the susceptor is heated significantly beyond ambient temperature by the exposure to microwaves.

The prior art has recognized the value of placing microwave susceptor plates in containers that partially or completely surround frozen food intended to be reheated in a microwave oven. The susceptor patch interacts with the microwave energy to become hot. The hot susceptor patch then acts as a radiant heat source (non-contact) or conductive heat source (contact) to augment the heating effect of the microwave oven on the frozen food. The selective application of radiant heat allows the process of heating food in a microwave to more closely approximate the heating process: in an oven, in a broiler, in a roaster, on a grill; or in a frying pan. This modification to the microwave process can modify the texture, browning, or crispness of the food.

Susceptors are often ultra thin films of metals such as aluminum deposited by vacuum evaporation or other means upon a polyester substrate. This polyester/metal susceptor is then bonded to paper paperboard. The susceptor can be rapidly heated by microwaves to a temperature of 400 degrees Fahrenheit. Other materials have been used as susceptors including steel, copper, and Inconel® alloy. The susceptor foil changes part of the microwave energy to a lower wavelength of infrared energy (heat.) The susceptor foil will partly shield food, while allowing partial microwave penetration. The thin metal is only a partial shield. Exposure to microwaves heats the very thin deposit of aluminum which browns and cooks the surfaces of food, baking by heating from the sides causing a convective movement of hot air, by broiling from above, by grilling with selective grill marks from above or below or by frying from below.

Unfortunately, the process of bonding the polyester/metal susceptor to the paperboard is not amenable to performance during the high-speed printing of the food packaging box in a flexographic printing press. The printing of the box is a necessary step in the preparation of the food packaging container with processing speeds of eight hundred to a thousand feet of box material per minute. Under current practices boxes are printed at high speeds and then cut into “folding carton flats” for further processing. For the purpose of providing context, FIG. 1 illustrates a set of examples of folded carton flats 104 in various configurations as known in the prior art.

It is after the creation of cut folding carton flats 104 that susceptors are applied. The folding carton flats 104 are typically shipped to another facility, where the folding carton flats are stacked and fed to machinery that slowly applies glue to each folding carton flat, one-by-one, on a conveyor belt. Next the process nips a roll of susceptor material to the folding carton flat and cuts the susceptor material as the folded carton flat continues down the conveyor belt and is restacked. The process of adding susceptors is actually the most expensive part of the creation of many food containers and is a significant bottleneck to the process to the point of stifling further beneficial use due to the difficulty in application and the additional expense of the material. The process of applying susceptors to folding carton flats can be 10 times slower than the process rates of printing the web containing the folding carton flats.

Recognizing the limitations of the bonded susceptors, companies such as James River and Westvaco experimented with films printed with carbon-based coatings in the mid 1990's. These efforts were hampered by difficulty in controlling the temperature of the susceptor films. In contrast to the ability to provide precise film thicknesses when making metallic films which can be distributed to a range of box makers, carbon-based coatings are printed (created) by the box maker. Precisely controlling the thickness of carbon based coatings is difficult given the range of printing press equipment manufacturers, variations in line speed, and a host of other factors. Variations in coating weights drastically affect the variations in the amounts of heat generated by the susceptors. A second problem with the use of carbon-based coatings is that while carbon heats up well, carbon coatings tends to conduct heat rather slowly compared to aluminum, and this localized heating tends to cause burning.

Thus, although the microwave oven has been with us for almost 60 years and the need to augment the microwave heating process has been known from the beginning of this technology, the prior art has not developed a satisfactory susceptor that can be applied economically and at high speeds.

It is an objective of the present invention to overcome limitations with the prior art susceptors.

It is an objective of the present invention to reduce the cost associated with adding susceptor zones to food packaging.

It is an objective of the present invention to provide a process for applying susceptor zones to food packaging that is compatible with applications as part of a high speed printing press that applies printed matter to containers for food such as cut folding cartons, pouches and bags, and disposable cooking implements, such as bowls, plates, boats, and other objects intended to contain food in a microwave oven while the food is being heated.

It is an objective of the present invention to provide a process compatible for use with a high speed printing press that will allow creation of patterned susceptor zones so that heat can be applied selectively to achieve specific thermal or aesthetic objectives.

It is an objective of the present invention to provide a process compatible for use with a high speed printing press that provides one or more susceptor zones that are appropriate for use with direct food contact.

While not all objectives will be achieved with every possible embodiment of the present invention, it is hoped that the present invention will be a useful addition to the methods available for creating a susceptor for packaging.

### SUMMARY OF THE DISCLOSURE

The deficits in the prior art are overcome and the objects of the present invention are achieved through the use of various processes described below that apply a layer of specific density metal (such as aluminum) encapsulated in a non-stick, direct food contact coating, to the food side of a container.

### BRIEF DESCRIPTION OF THE FIGURES

FIG. 1 illustrates a set of examples of folded carton flats 104 in various configurations as known in the prior art.

FIG. 2 illustrates the cold foil process as known in the prior art.

FIG. 3 shows greater details of the foil web 216 and web of material 204 before and after the prior art cold foil process.

FIG. 4 illustrates the layers of material for use in one embodiment of the present invention for applying susceptors through a modified cold foil process.

FIG. 5 shows a photograph of the foil transferred from the metallized film 504 to the paper board 508 to leave a susceptor pattern 512.

FIG. 6 shows the results of heating a piece of bread in the microwave in proximity to susceptors shown in FIG. 5.

FIG. 7 illustrates layers of a multilayered film that can be used in a hot stamp process.

FIG. 8 illustrates a hot stamping plate and a transferred pattern.

FIG. 9 illustrates the various components of interest in a hot stamp operation.

### DETAILED DESCRIPTION

Overview of Cold Foil Printing

The present invention is based on a previously known printing process that is known as cold foil printing. This form of printing is widely used for a variety of printing effects to add a metallic foil to a printed item. The most common use of cold foil printing is said to apply decorative foil to wine labels but the process is used for a wide range of printed material on stickers, labels, and packaging.

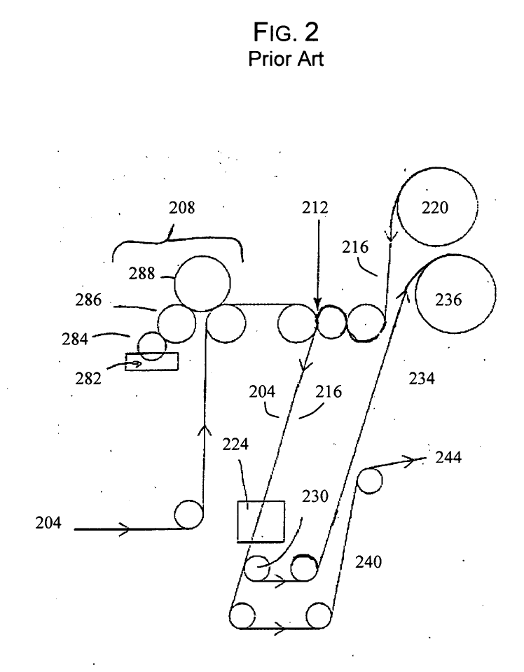

FIG. 2 illustrates the cold foil process as known in the prior art. A web of material 204 passes through a printing station 208 and receives a printed image of adhesive. More specifically, adhesive 282 is picked up by a fountain roller 284 which is transferred to an anilox roller 286 where excess adhesive is removed. The adhesive 282 is then transferred to the printing plate 288 so that an image of the printing plate 288 is transferred to the web of material 204. The web of material 204 with the printed adhesive 282 proceeds to an entry nip 212 where the web of material 204 with printed adhesive 282 is pressed against a foil web 216 that has moved from a foil unwind station 220 and is moving at the same speed as the web of material 204. The web of material 204 and the pressed foil web 216 pass through a dryer section 224 so that the adhesive 282 dries and becomes tacky. The web of material 204 and foil web 216 come to a stripping roll 230 whereby the portion of the foil web 216 not bound to the web by the now tacky adhesive 282 is stripped away as scrap and this scrap foil 234 proceeds to a foil rewind station 236. The enhanced web 240 with the foil now covering the printed adhesive 282 proceeds for further processing in the direction 244.

FIG. 2 is an example of wet lamination as the foil is applied to the adhesive while the adhesive is wet. There is a related process that partially dries the adhesive so that it is tacky before the foil is nipped to the web. This process is known as dry lamination.

The choice of using wet or dry lamination depends on the drying or curing equipment available on the printing press. The present invention can be used with either wet or dry lamination as long as the appropriate substitutions are used for the adhesive et cetera. Another variation in the process is the option of using ultraviolet light (“UV”) as part of the drying process instead of a dryer used for water based adhesives that typically use hot air.

The present invention can be extended to include the use of UV curable adhesives especially “cationic” UV curable adhesives for use in a web lamination process. The UV curable adhesive would be used in the cold foil application same as the water based adhesives would be used. The difference would be in the run speed of the converter's production line. If the production line is running at high speeds (above 200 feet per minute), the water based adhesive may not have enough time to dry properly prior to stripping off the PET carrier for the foil in which case a “cationic” UV curable adhesive would be a good alternative. The press set up for using a cationic UV adhesive would include ensuring that the adhesive is not placed on water-based or solvent-based inks that are not fully cured. It has been found useful to nip the foil within 5 inches of the UV dryer with a hard nip (85 durometer or higher) and a high degree of pressure.

Alternatively, electron beam (“EB”) curable adhesives could be used. EB curable adhesives typically have the same chemistry as non-cationic UV curable adhesives, however without the harmful free radical based photo initiators that are required to “spark” the chemical reaction that causes the monomer components of the adhesive to form chains of polymers in the UV curable adhesives. It is this chaining of the monomers that creates a solid from the liquid UV curable adhesive. EB uses an electron emitter that accelerates the electrons spun off of an element at high voltage. These electrons are moving at such high speed that when they hit the monomers, the chain reaction of forming polymers is both quick and thorough. In addition to completely curing the adhesive, EB does not introduce radiant heat to the web, making it possible to add susceptor material to a wider variety of packaging substrate, including unsupported films that are temperature sensitive. EB also has the added benefit of sterilizing the materials that are subjected to the accelerated electrons. The sterilizing effects of electron beam emitters are used in many fields including medical for sterilizing surgical implements, hospitals and in clean rooms to sterilize the air that flows into the environment. Thus as of the point of adding the susceptor, the packaging is sterilized.

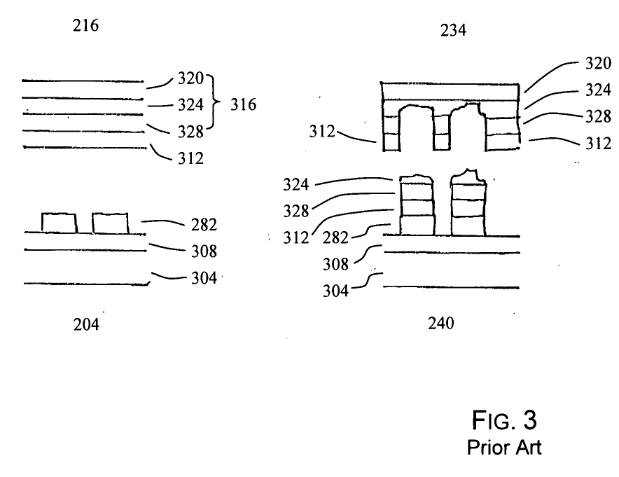

FIG. 3 shows greater details of the foil web 216 and web of material 204 before and after the prior art cold foil process. FIG. 3 is provided to illustrate the relevant components which have been sized to make them easy to label. FIG. 3 is not provided to show the dimensions or relative thicknesses of the various layers as ranges for the various thicknesses would be known or accessible by those of skill in the art.

Web 204 is comprised of the paper 302 and earlier printing stages that have coated the paper with ink 308 to minimize the absorption of the adhesive 282 into the paper 204 as absorption could interfere with the adhesion of the foil in precise lines. Web of material 204 has been printed with the adhesive 282 in the pattern to retain the foil from the foil web 216.

Foil web 216 which is frequently referenced in the art as the “foil” is actually a combination of the foil layer 312 and the foil backing 316. The foil backing 316 is illustrated here with a backer material 320 that serves as the webbing. This backer material 320 can be Polyethylene Terephthalate which is commonly abbreviated as PET or PETE (sometimes referenced as polyester or Mylar (Mylar® is a Du Pont brand name for flexible synthetic film)). Above the backer layer 320 is a layer of a release coating 324. Above the release coating 324 is a layer of nitro cellulose 328 which serves as a barrier coating. The nitro cellulose 328 serves as the foundation layer to receive the metallization layer. Above the nitro cellulose 328 is a layer of metal foil 312. The thickness of the foil 312 varies with the aesthetic effect desired with the printing process.

At the end of the cold foil process, web of material 204 has been altered in that the web of material has retained in the places with adhesive 282, the foil 312 and a portion of the foil base layer 316. Normally the release coating layer 324 is partially transferred to the web with retained foil 240 and partially left with the waste foil 234.

A Process for Applying Susceptors

After describing the prior art cold foil process that was typically used for purely decorative purposes to apply foil to labels and other packaging, this document will present a few illustrative embodiments of the present invention so that the concept of the invention can be conveyed through these illustrations. These illustrations are not intended to be an exhaustive listing of the various variations in products and processes that could be used to implement the present invention.

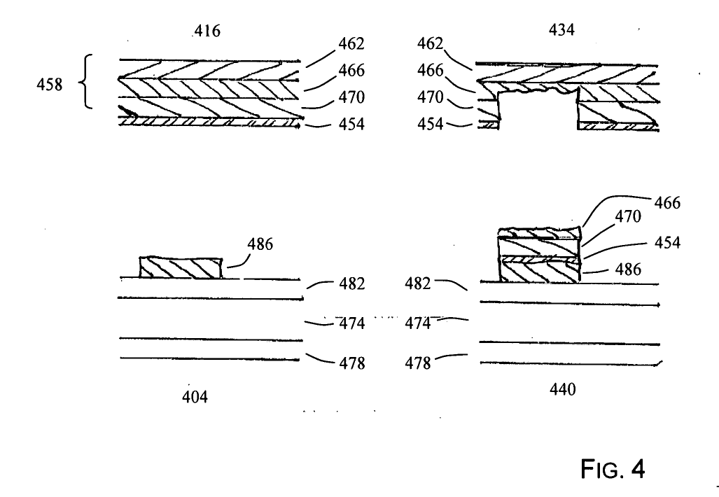

FIG. 4 illustrates the layers of material for use in one embodiment of the present invention for applying susceptors through a modified cold foil process. As in FIG. 3, FIG. 4 shows the four sets of material. Web of material 404 and web of foil 416 which are combined together before being separated into enhanced web 440 and scrap foil 434. The web of foil 416 has a layer of foil 454 and foil base 458. The foil base 458 has a backer layer 462, in this example a PET backer. On top of the backer layer 462 is a layer of a water base release coating 466 approved for use in situations where it will come into direct contact with food. On top of the release coating 466 is another water base FDA approved product for direct contact with food that acts as a barrier coat 470 to receive the metallization. Finally a thin layer of metal foil 454 is applied, such as by vacuum metallization or another process that can apply a precise amount of susceptor material. Note that as shown in FIG. 4, the metal foil 454 is shown on the bottom as the metal side of the web of foil 416 is positioned to make contact with the adhesive 486 despite the fact that the metal was added as the topmost layer when making the web of foil.

FIG. 4 is not drawn to scale but is drawn so that the layers can be seen and identified. The backer layer 462 is apt to be on the order of magnitude of 1 mil thick (25.4 microns). The release coat 466 is apt to be in the range of 3 to 8 microns. The barrier coat 470 is apt to be in the range of 6 to 12 microns. The foil layer 454 is much less than a single micron, more accurately measured in Angstroms or in the field, by transmissive density as described in more detail below.

The web of material 404 has a paper board 474 (substrate) that has been printed on the side that will be the outside of the container, shown here as printed layer 478. Optionally, the inside of the paperboard may have a wax layer 482 or some other barrier material used to enhance the properties of the paperboard with respect to serving as a container for frozen food. A printed layer of adhesive 486 such as a water base or FDA approved energy cured adhesive defines the regions of the paperboard to retain the foil layer 454 for use as a susceptor.

The thickness of the foil found to be useful as a susceptor applied with the modified cold foil process could be measured in angstroms. However, it is not practical outside of a laboratory to measure items in angstroms. The norm in the printing industry is to measure the optical density of a translucent film with a transmission densitometer such as those sold by X-rite, Gretag and others. Transmissive Density in this context equals log₁₀ (1/Transmittance) where transmittance is the amount of light that passes from a controlled source through the material being tested. Foils used for window tinting range in densitometer reading from 0.3 to possibly as high as 0.6. In contrast the foils used in cold foil processes for decorative purposes such as wine labels range between 1.3 and 1.8. Initial experiments have indicated that a cold foil process applying a foil with a transmission density (also called transmissive density) value in the range of 0.2 to 0.6 provides a usable susceptor, although this will vary depending on the particular application as factors such as the power level of the microwave oven and other factors may alter the viable range of foil densities.

Another variation of the construction of layers for the susceptor would involve the addition of a reflector layer. It is desirable to achieve high temperatures of radiant heat in the range of 375 to 400 degrees Fahrenheit. In the construction described above, the microwaves are emitted into the oven compartment and bounce randomly around the interior of the microwave oven. As some of these waves pass through the paper board packaging and the susceptor material, the molecules of aluminum are excited and as they move they bounce off one another creating friction. This friction generates heat which through the conductive properties of the aluminum are transferred to the adjacent material whether air, convective or radiant, or directly to the food as previously described.

Achieving the proper temperature for cooking the food contained in the packaging requires a very specific density of susceptor material. There are two things that are looked at to determine the appropriate temperatures for susceptor material: A) the initial temperature curve and B) the sustained temperature of the susceptor. The initial temperature curve is a measurement of how fast the susceptor reaches peak temperature while the sustained temperature is a measure of the temperature that the susceptor will maintain over the duration that it is exposed to microwaves. Collectively these two metrics are called the “Temperature Curve”. Different Temperature Curves are desirable depending on the food being heated or cooked and the method by which the food is being heated or cooked. For instance, if the package is in direct contact with a piece of chicken it would be desirable to reach 375 to 400 degrees Fahrenheit within 2 to 4 seconds and sustain that temperature for the entire duration of cooking, whereas if the food being heated were a breakfast roll that was being warmed via indirect contact with the susceptor it would be more desirable for the susceptor to reach a temperature of 275 to 325 degrees Fahrenheit within 2 to 4 seconds and maintain that temperature for the duration of the cooking time.

Obtaining specific properties in the temperature curves can be achieved by modifying the density of the aluminum. Less density allows more penetration of the microwaves through the aluminum thereby creating more interaction between the molecules and the microwaves which in turn creates more movement of the molecules and generates more heat more quickly. A higher density of aluminum will interfere with the penetration of the microwaves. At very high densities of aluminum, this interference will actually act as a shield to protect anything covered by the aluminum from exposure to the microwaves. Likewise a moderate amount of aluminum will have a partial shielding effect, only allowing a small amount of microwaves to penetrate and interact with the molecules, causing less friction and lower temperatures.

By creating a layered structure which includes both low density and high density metal areas, it is thought possible to effectively concentrate the microwaves and accelerate the frequency that they pass through the low density layer. The layering would be as follows: A) film backing, B) release coat, C) barrier coat, D) low density aluminum, E) insulator coat, and F) high density aluminum.

The pair of metallic layers are transferred to the packaging material in a single pass in the same manner as described above. As the microwaves pass through the low density layer of aluminum, the molecules of aluminum are excited to movement. Then rather than passing through the package substrate material and being allowed to bounce freely around the interior of the oven, the microwaves bounce off of the high density layer of aluminum reflecting them back through the low density layer of aluminum. This creates a higher frequency of interaction between the microwaves and the aluminum molecules in the low density layer effectively accelerating the temperature curve of the susceptor. The insulator coat bonds to the low density aluminum and separates it from the high density aluminum so that the two layers operate independently. The insulator layer being penetratable by microwaves.

By varying the densities of the reflector and susceptor layers a great deal of temperature curve control can be achieved. Additionally, by pattern transferring the susceptor material, apertures can be created to allow unhindered penetration of microwaves through areas of the packaging that do not have any susceptor material while focusing the microwaves in the areas that do. For example, if the package completely surrounds the food with the low density layer of aluminum facing the inside of the container and apertures are created where no susceptor is present through pattern transfer of the susceptor material, microwaves will enter the container through these apertures and once inside the container will bounce around, focusing the interactive energy of the microwaves on the susceptor material increasing the temperature of both the ambient air and susceptor which is in direct contact with the food.

### EXAMPLES OF ALTERNATIVE EMBODIMENTS

While the specification discloses a particular embodiment of the present invention through the context of placing susceptor material on what will end up as the inside of a box to be used for frozen food, the invention is not limited to that specific application. The same process can be applied to advantageously apply susceptor material to other end products. For example in the context of rotary printing equipment, the same principles used for applying susceptors to a web that will ultimately be converted into flats for food boxes could be used to create bags or pouches used for microwave cooking. Obviously the present invention is not limited to frozen foods as microwave ovens are used to heat food items that are not frozen, including but not limited to, popcorn and various meat products.

Processes known in the art for printing on stock to be formed into bowls, trays, plates, or other implements used to hold food during while the food is in a microwave could also benefit from the disclosed invention. Advantageously, the FDA grade release coating which is proximal to the food after the cold foil process is useful in preventing food from sticking to the susceptor during or after heating.

It is within the scope of the present invention to apply a coat of the release coat to the web after the cold foil printing process so that all of the web material apt to come into contact with heated food will have a release coat to eliminate or greatly reduce the likelihood that the heated food will stick to the product formed in accordance with this invention.

Experiment A

Using a film that had a wax based release coat and a nitrocellulose barrier coating (a film that we used in other cold and hot foils) a thin aluminum coating was applied to the film. The transmissive optical density of the thin aluminum coating, as measured with an Xrite densitometer was 0.55. A piece of the film was placed in a microwave oven with a piece of Wonder® brand bread on top of the film with the aluminum coating. The microwave oven was operated on high for 45 seconds. After 45 seconds, the top face of the bread was still white, soft, and moist. The bottom face of the bread which had been next to the film with the coating was brown. The brown side of the bread looked and felt like it had been toasted in a conventional toaster.

Experiment B

A food package box was obtained from a grocery store and the food in the box was removed. The box was opened and film from the same batch used in Experiment A was taped to the inside of the box. A piece of Wonder® brand bread was place on the foil taped to the box and the box was folded over so that a portion of the box with film was above the bread. The box with the bread was heated in a microwave for a minute. The top face of the bread was found to be nicely toasted. The bottom of the bread was a little over done but still looked good.

Experiment C

The next experiment tested the ability to transfer the aluminum directly to some paperboard. The aluminum on a roll of metallized film was coated with some PVC primer which is a standard coating used as an adhesive to make hot stamping foil. Using a hot stamping machine, the aluminum and nitrocellulose barrier coat were transferred to the paper board. The paper board was cut into pieces that were slightly larger than a slice of the Wonder® brand bread. A slice of bread was placed upon a piece of coated paperboard with a second piece of coated paperboard in direct contact with the top face of the bread. The microwave oven was operated for 15 seconds and the bread was found to be very lightly toasted. After another 15 seconds of microwaves, the bread looked like a perfect piece of toast, evenly browned and crisp on both sides.

Experiment D

The next experiment tested the ability to generate a cooking pattern on the bread by selectively applying the aluminum and barrier to the paperboard. A printing plate with an alternating wavy stripe pattern similar to the stripes in the US flag was used to apply adhesive (PVC primer) to another roll of metallized film. The adhesive was allowed to cure. The film with the cured adhesive was laid on top of the paperboard.

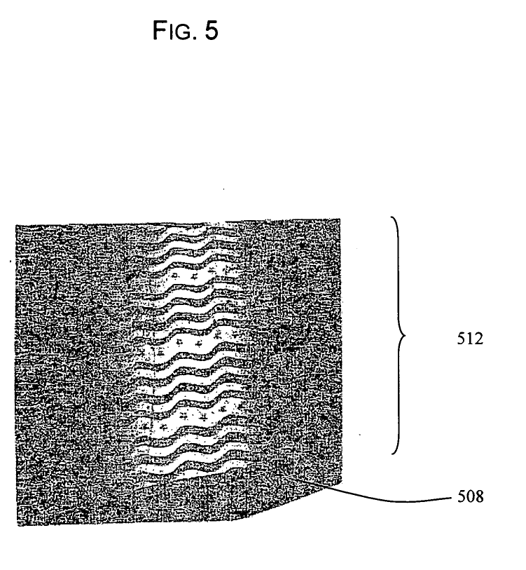

The aluminum was transferred to the paperboard by a type of hot-stamping process which applies substantially uniform pressure and heat to the metallized film. This heat and pressure caused the cured adhesive to become tacky again. Thus the printed pattern of adhesive caused a corresponding transfer of aluminum to the paperboard. Only the areas that had PVC primer on them transferred from the foil web to the paperboard to substantially replicate the wavy striped pattern. FIG. 5 shows a photograph of the foil transferred from the metallized film 504 to the paper board 508 to leave a susceptor pattern 512. (as noted below, the use of non-thermosetting adhesives is apt to cause problems in cooking applications as the adhesive when heated by the susceptor will become soft and allow the susceptor material to release and bind to the food)

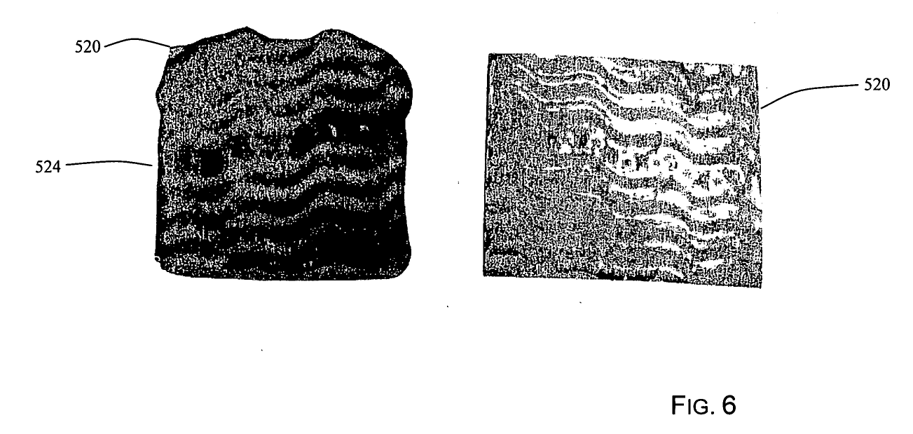

As shown in a photograph presented as FIG. 6 after heating in the microwave, the paper board was cut into pieces 520 that were slightly larger than a slice of the Wonders brand bread 524. A slice of bread was placed upon a piece of coated paperboard in direct contact with the top and bottom faces of the bread. The bread 524 and paper board pieces 520 were placed in a microwave oven and the oven was operated for 30 seconds. The result is shown in FIG. 6 which is a photograph of the piece of bread that looked like it had been toasted on a grill with a wavy grill iron. Thus, a grill pattern had been transferred to the toast demonstrating that other patterns could be transferred to food such as faux grill marks to a piece of meat to emulate the marks that a piece of meat would obtain when placed on a hot barbecue grill or simply fanciful decorations such as outlines of cartoon characters or animals to make food prepared for children more attractive or distinctive.

The test did not use materials intended for contact with food. For example nitrocellulose was not chosen as an example of a food grade material. However, the tests did prove that a susceptor could be created in this manner and the susceptor could be used to alter the way the food was heated. Given that aluminum is already considered to be FDA compliant for direct food contact (aluminum foil and most standard cookware available on the market) and that there are off the shelf coatings that can be obtained from a variety of sources for the Release, Barrier and Adhesive coatings, the test results demonstrated the feasibility of the invention.

### EXAMPLES OF MATERIALS

The following materials are thought to be suitable for use in the creation of an FDA suitable foil web. Foil backer layer 462 can be material such as used as the backer layer for FDA approved PET browning strip transfer film (or BOPP Bi-Oriented Polypropylene (cold foil only, not for use with hot foil). SKC Skyrol® Polyester film is another suitable material. A data sheet is included in the Appendix for Skyrol® Polyester film.

The FDA suitable release coating 466 could be coating used for coating aluminum baking sheets such as the product (Ink F-17023) provided by Merrit Inks for that use. An FDA “no objection” letter for this product is included in the Appendix. The product forms a very slippery surface that is clear.

Because the barrier coat 470 is applied immediately after the release coat is applied, a good bond is formed between these coats. The release coat 466 does not form a permanent bond with the PET 462 and therefore releases with the metal 454 and barrier coat 470 in the cold foil process. The advantage of this is that the release coat 466 forms a non-stick surface over the metal layer in the food package which aids in both preventing the food from sticking to the susceptors and in keeping any of the metal from the metal layer 454 or barrier coat 470 from transferring to the food.

One suitable FDA approved coating for a barrier coat 470 that will accept vacuum metallizing is made by Environmental Coatings Inc. More specifically it is a product called EC0005. A Technical data sheet for this product is included in the Appendix.

As noted above, the type of adhesive used in the process is a function of which process is being used (wet lamination, dry lamination, UV cured dry lamination, EB, et cetera) and the characteristics of the specific equipment being used (run rate, ability to dry or cure quickly, etc.). Two adhesives thought to be suitable candidates are: FDA approved waterbase pressure-sensitive adhesive, Rad-Cure 5565, and FDA approved UV cationic window adhesive, K6003B, also see technical data sheet in the Appendix. Both are products of RAD-CURE Corporation of Fairfield, N.J.

While the preferred embodiment of the present invention is to use cold foil printing on a process performing rotary printing on a web of material, other embodiments of using printing foil can be used to apply susceptors.

Sheet Fed Printing

Cold foil is suitable for printing on a web print process but is not yet developed for a sheet-fed system. About one-half of folding carton print production is done on these sheet-fed presses, at a slower rate than web printing, but still a significant portion of the market. The food-grade foil described above can be applied and used with these press sheets as well with the addition of a heat activated adhesive on the last layer of the receptor foil. An offset printer may work with sheets that have from four to eight flat box layouts per sheet of a particular box. In the prior art practice of applying decorative foil to the external face of the box, sheets are sent out to a finisher to process pallet loads of sheets through a hot-stamp machine in order to add decorative foils to the outside of the box.

Adapting the hot-stamp sheet fed process for use with the present invention would include creating a metal plate in the image desired for the susceptor placement. The metal plate would be mounted to a metal platen which has a heating element attached. The foil is spooled so that it unwinds on one side of the press, and comes between the hot die and the paperboard or substrate to be hot-stamped, and the waste rewinds on the other side of the press. The sheets advance one-at-a-time into the press, and the hot die presses against the paper or substrate and holds for a short time and releases. After the pressure is released and the roll of foil advances to a new un-used section, the finished sheet is ejected with the applied hot-stamped image and a new sheet is advanced into the press.

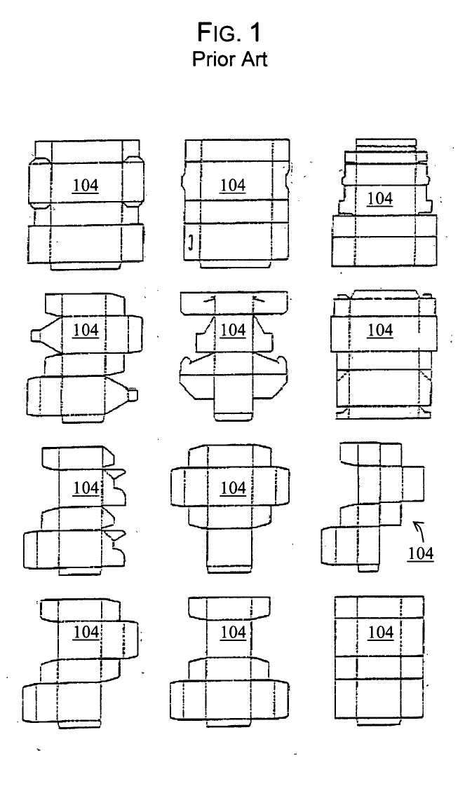

The hot-stamp process is not as fast as the cold foil process, but it is a common process and there is a considerable amount of equipment in place that can use this process. One advantage of the sheet fed process is that it can be used for small runs as it can run against one sheet at a time. The processor can quickly change the metal plate to adjust to different flat box layouts (See FIG. 1 for a sample of the wide range of folded carton flats 104).

With that overview of the need for the hot stamp process for sheet fed material, the following explanation provides greater detail.

Hot Stamp Process

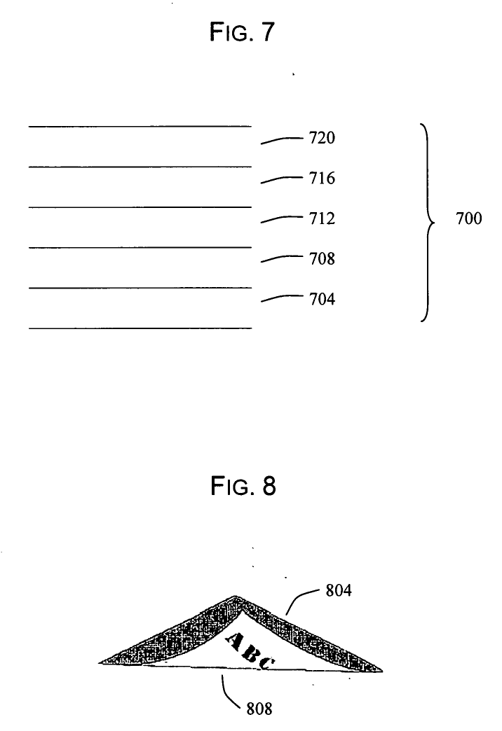

A multilayered film 700 suitable for a hot stamp process is illustrated in FIG. 7. (again the figures are used to illustrate components not dimensions). Each layer performs a specific role in the final multilayer film product. The layers are:

A) A carrier film 704 typically made of thin gauge polyester. The role of the carrier film 704 is to be a vehicle to receive the subsequent layers. Polyester is a popular material for this because polyester is dimensionally stable in both directions. Additionally polyester is capable of withstanding very high temperatures.

B) A release coat 708 is then applied to the carrier film 704. The release coat 708 is heat sensitive and keeps the subsequent layers from bonding to the carrier film 704.

C) A barrier coat 712 is then applied to the release coat 708. The barrier coat 712 acts as a durable top coat when the layers are released from the carrier film 704. The barrier coat 712 also helps keep subsequent layers from migrating through the release coat 708 and adhering to the carrier film 704.

D) The film is then metallized with a thin layer of metal (aluminum in this case) to form a metal coating 716. The transmissive density range that is suitable is the same as in the cold foil version.

E) Finally a heat activated adhesive 720 is applied to the top of the metal coating 716. The adhesive 720 is the layer that comes in contact with the paper board substrate (not shown here). The adhesive 720 adheres the multilayered film 700 to the paper board. Best results are obtained with a heat-activated thermosetting adhesive which becomes permanent after the heat cycle of the hot-stamp process. Bond strengths of conventional (non-thermosetting) heat-activated hot-stamp adhesives weaken when reheated, and are not ideal for bonding susceptor material with some direct contact food/package combinations. Fatty foods attach themselves to the susceptor during microwave process, and the susceptor material bonded with the conventional (non-thermosetting) hot-stamp adhesive tends to pull away from the package material.

All layers after the release coat bond with each other to form a multi-layered film 700.

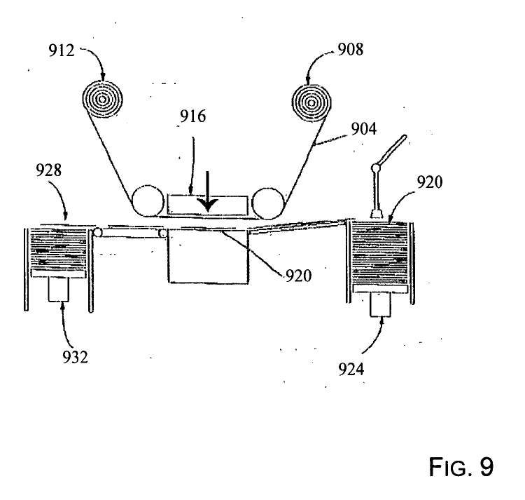

As illustrated in FIG. 8, a hot stamping plate 804 is patterned with high and low areas to transfer the desired pattern 808. The high areas will make contact with the foil while the low areas will not.

FIG. 9 illustrates the various components of interest in a hot stamp operation. The hot stamping foil 904 is provided to the converter in rolls of a length that optimizes their production runs. The roll of foil 904 is mounted to run from an unwind section 908 to a rewind 912 after running through the press. The hot stamp plate (such as 804 in FIG. 8) is mounted to the underside of the hot stamping platen 916 which is heated. The paper board sheets 920 are loaded into the in-feed pallet 924. The paper board sheets 920 are picked up and fed into the press one at a time. When a paper board sheet 920 is in the press, the hot stamping platen 916 comes down for a specific dwell time (often in the range of one to two seconds). The hot stamping platen 916 heats the hot stamp plate which sandwiches the foil and paper board between the platen and the stationary anvil plate (sometimes called a striker plate).

The hot stamp plate activates the release 708 and adhesive 720 coats of the multilayered film 700 causing the layered package to release from the carrier film 704 and adhere to the paper board sheets 920 only in the impression areas of the plate. The enhanced paper board sheet 928 is then advanced into the out-feed pallet 932 and the cycle starts again.

The prior art included variations in how the hot stamp is created and moved in order to create the impression on the foil. These variations are not germane to the present invention but represent trade-offs understood by those of skill in the art between costs to produce the hot stamp, production speeds, and the desirability of using legacy equipment.

With the illustrations of the cold foil printing for a web based press and the hot stamp process for a sheet fed press, one can appreciate that the present invention can be used with a hot stamp process used with a web based process. Such a process has the advantage of high speeds but has the disadvantage of the cost of a hot stamp for use in a rotary process. Likewise a sheet fed device using a cold foil process could be adapted to use the present invention.

With this understanding of the process, one of skill in the art can appreciate that the process can be practiced with hot presses of any type including those using a rotary hot press and those using a clam-shell press.

Windowing Process for Applying Susceptor Film to Sheetfed Packages

Additional alternative embodiments for applying microwave susceptor material to individual paperboard or film packages is to use legacy equipment used in prior art to apply clear window film to individual packages. The process of applying clear window film is commonly used in the industry to apply clear polyester or Bi-Oriented Polypropylene (BOPP) films from between 1 to 2 mil in thickness to the perimeter of die cut areas of the package such as donut or golf ball boxes so that the consumer can see the product before buying and the product maintains freshness without opening the package seal.

One alternative embodiment is a two-step process, and uses the film construction previously describe for cold foil. The PET aluminum metallized susceptor film is converted to a pattern film in step number one for later application on legacy window laminating equipment which is step number two. The PET film serves as a functional barrier between the susceptor and adhesive as described in prior art for FDA indirect and direct food contact applications.

Step One: A susceptor film construction (PET base, water base release coat, metallized layer) is nipped under pressure to a paper base printed in a pattern with a FDA compliant pressure-sensitive adhesive or laminating adhesive. This pattern defines the area to be free of the microwave susceptor material. (Thus the adhesive is applied where susceptor material is not desired, the reverse of the embodiment described in connection with FIG. 4). The susceptor film and paper then separate and the areas in mutual contact with the adhesive 720 separates from the PET liner 704 and release coat 708 as the areas are adhered to the paper. In this embodiment, the paper rather than the take up roll of film is discarded as waste. The PET film with the remaining susceptor pattern is then rewound and saved for use in step number two.

Step Two: starts with a printed package without a die-cut hole and selectively prints adhesive—either hot-melt, air-dry or UV/EB curable—to the package, usually the inside, as this will be the side facing the food product when microwaving. Window application machinery selectively applies adhesive to an individual package with a flexible rubber or photopolymer plate in the areas bonding the susceptor film to the paperboard or film package. The selective adhesive only needs to bond the film and susceptor coating to the packaging substrate for strength and support purposes, and can be applied selectively in a light pattern. The adhesive is cured in the appropriate manner, by cooling in the case of hot-melt adhesive, by drying in the case of air-dry adhesive, by ultraviolet curing lamps in the case of UV adhesive or and electron-beam curing device in the case of EB adhesive.

When the package is assembled and used for browning food during the microwave heating cycle, the polyester PET liner faces the food and serves as a barrier between the metallic microwave susceptor material and adhesive, allowing for use with foods that become sticky when microwaved such as chicken, meat, and fatty foods. When food is removed, the microwave susceptor material remains attached to the paperboard even when overcooked.

Another embodiment of this invention uses UV or EB curable cationic adhesive, described in the cold foil web printed embodiment discussed above. The multi-layer susceptor film is nipped to the paperboard (or film if film is used instead of paperboard for the packaging) with selectively printed adhesive. The susceptor film and packaging material pass under an intense UV curing lamp which instantly bonds the susceptor film and packaging material. The waste PET film separates and rewinds away from the packaging material enhanced with the susceptor. This leaves the thin susceptor material transferred in the desired pattern on the microwave packaging containers that continue along the vacuum belt and are stacked in a hopper for shipping to the end customer for food packaging.

One of skill in the art can appreciate that the adhesive used for this transfer method must be suitable for the appropriate level of food contact including both indirect and direct food contact as defined by the FDA.

One of skill in the art will recognize that the alternative embodiments set forth above are not universally mutually exclusive and that in some cases alternative embodiments can be created that employ aspects of two or more of the variations described above. Likewise, the present invention is not limited to the specific examples or particular embodiments provided to promote understanding of the present invention. Moreover, the scope of the present invention covers the range of variations, modifications, and substitutes for the components described herein as would be known to those of skill in the art.

The legal limitations of the scope of the claimed invention are set forth in the claims that follow and extend to cover their legal equivalents. Those unfamiliar with the legal tests for equivalency should consult a person registered to practice before the United States Patent and Trademark Office.

What is claimed is:

1. A method of applying a pattern of microwave susceptor material to a substrate, the method comprising:
applying a pattern of adhesive to the substrate corresponding to the pattern of microwave susceptor material desired for the substrate;
placing a multilayer web containing a susceptor layer in contact with the substrate and adhesive pattern;
allowing the adhesive to at least partially cure; and
separating the multilayer web from the substrate and leaving behind susceptor material where the adhesive pattern was applied.

2. The method of claim 1 wherein the substrate material is being prepared as a set of at least one folding carton flat and the microwave susceptor material is applied to what will become the inside of a food container box.

3. The method of claim 1 wherein the substrate is being prepared to be a pouch for containing food and for use while heating the food in a microwave oven.

4. The method of claim 1 wherein the substrate is being prepared as a disposable implement suitable for use in heating food in a microwave oven.

5. The method of claim 1 wherein the substrate to receive the pattern of adhesive is paperboard covered by a barrier material to limit the absorption of the adhesive into the paperboard.

6. The method of claim 1 wherein the substrate is covered on one side with barrier material to limit the absorption of the adhesive into the paperboard and on the opposite side has a pattern of ink.

7. The method of claim 1 wherein multilayer web containing a susceptor layer is comprised of:
a backer layer;
a release coat layer;
a barrier layer; and
a layer of metal.

8. The method of claim 7 wherein the layer of metal has a transmission density in the range of 0.2 to 0.6.

9. The method of claim 7 wherein both the release coat layer and the barrier layer are made from water base materials suitable for direct contact with food.

10. The method of claim 1 wherein the multilayer web containing a susceptor layer is comprised of:
a backer layer;
a release coat layer;
a barrier layer;
a low density layer of metal adapted to become hot through interaction with microwaves in a microwave oven;
an insulator coat; and
a layer of high density metal adapted to reflect microwaves in a microwave oven.

11. The method of claim 1 wherein step of allowing the adhesive to at least partially cure includes the application of ultraviolet light to the adhesive.

12. The method of claim 1 wherein step of allowing the adhesive to at least partially cure includes the application of energy to the adhesive from an electron-beam curing device.

13. The method of claim 1 wherein step of allowing the adhesive to at least partially cure includes the cooling of a hot-melt adhesive.

14. The method of claim 1 wherein step of allowing the adhesive to at least partially cure includes the drying of the adhesive.

15. A web of foil for use in applying microwave susceptor material to a substrate, the web of foil comprising:
a backer layer;
a release coat layer;
a barrier layer; and
a layer of metal;
wherein the layer of metal has a transmissive density in the range of 0.2 to 0.6.

16. The web of foil of claim 15 wherein both the release coat layer and the barrier layer are made from water base materials suitable for direct contact with food.

17. The web of foil of claim 15 wherein the multilayer web containing a susceptor layer is comprised of:
a backer layer;
a release coat layer;
a barrier layer;
a low density layer of metal adapted to become hot through interaction with microwaves in a microwave oven;
an insulator coat; and
a layer of high density metal adapted to reflect microwaves in a microwave oven.

18. Paperboard being prepared as a folded box flat, the paperboard having an outside surface and an inside surface, the outside surface having received printed matter, the inside surface having received a printed pattern of adhesive with at least one void; a layer of metallization adhered to the adhesive and duplicating the printed pattern of adhesive, the layer of metallization covered by at least one material suitable for contact with food.

19. A multilayer film suitable for use with a hot stamp process to apply microwave susceptor material in a pattern; the multilayer film comprising:
A) a carrier film;
B) a release coat above the carrier film, the release coat made from a material suitable for direct contact with food;
C) a barrier coat above the carrier film, the barrier coat made from a material suitable for direct contact with food;
D) a layer of metal above the barrier coat, the layer of metal having a transmissive density in the range of 0.20 to 0.60; and
E) a heat activated thermosetting adhesive applied to the layer of metal in a pattern selected to apply microwave susceptor material to a substrate.

20. A method of applying a pattern of microwave susceptor material to a substrate comprising:
obtaining a multilayer film, the multilayer film comprising:
A) a carrier film;
B) a release coat above the carrier film, the release coat made from a material suitable for direct contact with food;
C) a barrier coat above the carrier film, the barrier coat made from a material suitable for direct contact with food;
D) a layer of metal above the barrier coat, the layer of metal having a transmissive density in the range of 0.20 to 0.60; and
E) a heat activated thermosetting adhesive applied to the layer of metal in a pattern selected to apply microwave susceptor material to a substrate; and
pressing a portion of the multilayer film against a substrate while applying heat to the multilayer film so that a pattern of metal is transferred to the substrate corresponding to the pattern of heat activated thermosetting adhesive.
